(19) United States
(12) Patent Application Publication
(10) Pub. No.: US 2019/0255826 A1
(43) Pub. Date: Aug. 22, 2019

(54) COMPOSITE MATERIAL, IN PARTICULAR FOR SPORTS EQUIPMENT

(71) Applicant: Bufo Technology UG, Hannover (DE)

(72) Inventor: Rouven Dirk BRAUERS, Hannover (DE)

(73) Assignee: Bufo Technology UG, Hannover (DE)

(21) Appl. No.: 16/346,876

(22) PCT Filed: Oct. 27, 2017
(86) PCT No.: PCT/EP2017/077569

§ 371 Date: May 2, 2019

(30) Foreign Application Priority Data
Nov. 3, 2016 (DE) 10 2016 120 931.7

(51) Int. Cl. B32B 27/20; B32B 27/06; B29C 70/02

(52) U.S. Cl. CPC B32B 27/20; B32B 27/06; B29C 70/025; B29K 2511/02; B32B 2605/00; B32B 2307/402; B32B 2307/7163; B32B 2264/04

(57) ABSTRACT

The invention relates to a composite material (20), in particular for producing sports equipment. It comprises at least one mixed layer made from cork granules (22) and short fibres (24).

The present invention relates to a composite material element that can be used, in particular, for the manufacture of sports equipment.

Sports equipment such as, in particular, surfboards, sailboards, wakeboards, kneeboards, kiteboards, skimboards or skateboards usually consists of a base body that has a board-like shape with an upper side and an underside. The aforementioned examples of sports equipment are subjected to considerable physical loads while they are in use. These loads include, in particular, compressive/tensile loads, shear loads and torsional loads. Consequently, the sports equipment must be sufficiently robust, but should nevertheless have sound damping properties and a low weight. These aspects are essential for a very smooth operation and control of the sports equipment.

The aforementioned water sports equipment usually comprises a core of foamed material that is encased with a laminate. In this case, the laminations may consist, for example, of a polyester resin or epoxy resin and a glass fiber material. The foam body itself is made, for example, of polystyrene or polyurethane. Fiber composites or plastic composites (GFRP or CFRP) are frequently used as outer layers. They increase the torsional or flexural strengths depending on their orientation.

In contrast, a particularly simple variation of skateboards is made of plastic, but skateboards preferably consist of a wood of the group of veneer plywoods and are usually composed of seven layers. Canadian or Baltic maple is particularly suitable for the manufacture. The problem with skateboards can also be seen in providing an optimal compromise between a high resistance to compressive, shearing and torsional forces and sufficiently high damping.

The invention is based on the objective of making available a composite material element that is suitable for the manufacture of the aforementioned sports equipment and has enhanced properties in comparison with the disadvantages of the prior art. It should be possible to easily and cost-efficiently manufacture a composite material element, which should also have particularly sound damping properties. The invention furthermore aims to make available a method for manufacturing such a composite material element.

This objective is attained with a composite material element that comprises at least one mixed layer of cork granules and short fibers. The objective of the invention is furthermore attained by means of a method with the characteristic features of the independent procedural claim.

In the following description, the term mixed layer is used for the inventive layer consisting of a mixture of cork granules and short fibers.

The mixed layer may be arranged in the interior between two additional laminate layers, e.g. a top layer and a bottom layer, but it is also conceivable to arrange the layer directly on the upper side or underside. The arrangement of multiple inventive mixed layers within a multilayer composite material element is likewise conceivable. The inventive composite material element may furthermore comprise layers that are made of woven fabrics or nonwoven staple fabrics.

It is generally known to use cork plates as sandwich cores due to their excellent damping properties. However, the breaking strength of commercially available cork products does not suffice for competition-oriented loads or correspondingly high loads during the performance of the sport with the aforementioned sports equipment. Cork naturally has only low compressive and shear strengths, which is the reason why cork is not suitable for sandwich structures that are subjected to high loads. According to the invention, this disadvantage is effectively compensated due to the addition of short fibers. The addition of carbon fibers proved particularly effective because these fibers increase the mechanical load capacity many times over without negatively affecting the advantageous damping properties.

The properties of the mixed layer can be advantageously influenced with the volumetric contents (quantity) of the fibers and the fiber type. The length of the fibers may vary, for example, between 0.05 mm and about 6 mm, preferably between 0.1 mm and 0.3 mm. According to the invention, the cork granules may have a density of about 50 kg/m³-300 kg/m³, wherein a density of about 90 kg/m³-250 kg/m³ proved particularly suitable. The properties of the mixed layer and of the composite material element manufactured thereof can also be influenced with the density of the cork granules.

It was determined that the use of short fibers not only significantly increases the compressive and shear strengths in comparison with conventional cork plates, but also significantly reduces the occurrence of so-called intermediate fiber fractures within the composite material element. This can be attributed to the fact that laminate boundary surfaces, which are provided with a cork fiber coating, have a significantly better capability of absorbing occurring shear stresses.

The mixed layer is produced by means of compressing, heating and/or bonding. In this case, it is possible to use the cork's own resin or added synthetic resin such as epoxy resin, polyurethane, vinyl ester, bioresins, polyester, acrylic resins, etc. Compressed or bonded blocks can be cut into layers or plates of different thicknesses and comprise a three-dimensional fiber reinforcement, which causes the significantly enhanced physical properties. Alternatively, complex shapes can also be directly cut or manufactured from the produced mixed layer instead of flat, board-like composite material elements. It is also conceivable to use arbitrary molds, into which the liquid mixture of cork granules and short fibers is introduced for curing.

It is basically possible and advantageous to use the inventive mixed layer by itself, i.e. without another layer of a different material, but the mixed layer itself has a lower load capacity than other materials. In this respect, a very advantageous composite material element particularly is achieved due to the addition of other layers, especially outer layers (classic sandwich structure) of different materials with other desirable properties.

Cotton, flax, basalt, glass, carbon, synthetic fibers (Vectran), aramide, coconut, hemp, silk, wool, bamboo, kozo, gampi, abaca, pine kraft and jute may be considered as short fiber material. In this case, the materials may be mixed with the cork granules in the form of a single additive, as well as in combination with one another.

For use as a core layer or intermediate layer, it was determined that the grain size or grain diameter of the cork granules preferably should lie between 0.1 mm and about 20 mm in order to achieve optimal physical properties. If the inventive mixed layer is used as a top or bottom layer, a grain size of the cork granules between about 0.1 mm and about 2 mm proved particularly advantageous.

The cork granules preferably are on hand in expanded form. They are mixed with the short fibers in such a way that the two materials are uniformly distributed among one another.

The composite material element preferably is made of biodegradable materials. For example, either only the cork's own resin is used or only bioresins are used as additives. Most bioresins with sound technical properties currently have an organic content of up to 70%. In this case, the short fibers also consist of biodegradable materials.

Another significant advantage of the inventive mixed layer of cork granules and short fibers can be seen in that it does not absorb any water and is resistant to mold. It is therefore particularly suitable for the manufacture of water sports equipment.

The inventive composite material element may comprise, for example, at least one additional layer of glass. In the simplest variation, only one layer of glass and one layer of the mixture of cork granules and short fibers are provided. However, the mixed layer may also be arranged between two glass layers, for example in skis, skateboards or snowboards, wherein it would even be possible to advantageously provide three glass layers, which respectively border on mixed layers. In other words, respective glass layers are provided on the outside and border in the direction of the interior on two mixed layers, which in turn are separated from one another by a central glass layer. According to the invention, it is basically also possible to provide even more glass layers and/or mixed layers.

According to a third variation, mixed layers can be used directly on one of the outer sides. It is also advantageous to arrange two mixed layers on the outside, wherein a different material, for example a glass layer, is provided in the interior, i.e. between the two mixed layers. In a surfboard, the foam core is provided in the interior.

It is ultimately also conceivable to use at least two glass layers in the interior of the inventive composite material element.

In another advantageous variation, the composite material element comprises in the interior a foam core that borders, for example, on a layer of carbon or a glass fiber laminate. An inventive mixed layer may then once again be arranged on the outside. However, the mixed layer may also be provided between the foam core and the layer of carbon or a glass fiber laminate.

In addition to glass, various other materials are also suitable for being combined with the inventive mixed layer. Cotton, flax, basalt, glass, carbon, synthetic fibers (Vectran), aramide, coconut, hemp, silk, wool, bamboo, kozo, gampi, abaca, pine kraft and jute may be considered as laminate material. In this case, the materials may be mixed with the cork granules in the form of a single additive, as well as in combination with one another.

The composite material element is not only suitable for the manufacture of sports equipment, particularly water sports equipment and skateboards, but can also be used in other fields, in which lightweight, robust and nevertheless vibration-damping materials are required. It may be used, for example, in the construction of aircraft or ships or generally in the construction of vehicles. Inventive composite material elements are furthermore suitable for components of wind power plants, e.g. wind turbine blades, for underwater turbine blades and generally also for components of buildings such as awnings or sunroom frames.

According to the invention, the two materials can be bonded to one another with only the cork resin, which is present in the cork anyway. However, an adhesive may alternatively be added. This adhesive particularly may consist of a biodegradable adhesive such as bioresins or similar suitable adhesives.

An inventive method for manufacturing a composite material element comprises the following steps:
grinding cork into cork granules,
producing short fibers of a second material,
mixing and bonding the cork granules with the short fibers,
curing the mixture of cork granules and short fibers.

According to the invention, the two materials may also be compressed under pressure in an additional step or simultaneously with the bonding process. A compression under vacuum or the use of an autoclave (a hyperbaric chamber) is particularly suitable for this purpose. The production of the individual layers for manufacturing the actual composite material element or the finished product may be carried out manually or with suitable processes.

In sports equipment with a foam core such as surfboards, for example, it proved particularly advantageous to provide the mixed layer with short fibers on the outside. This leads to maximum robustness of the sports equipment. Nevertheless, it may also be sensible to provide a layer of synthetic resin and cork particles, which does not contain any short fibers, on the outside. In a particularly advantageous variation, the layer arranged on the outside, i.e. the mixed layer or the layer of synthetic resin and cork particles, is colored black. This leads to an optically appealing appearance after the final processing, preferably after sanding of the sports equipment. In addition, the layer lying thereunder is frequently also black, for example if it is made of carbon.

The invention is described below with reference to the figures, wherein these figures should only be interpreted as examples and the invention is not limited to these examples. In the figures:

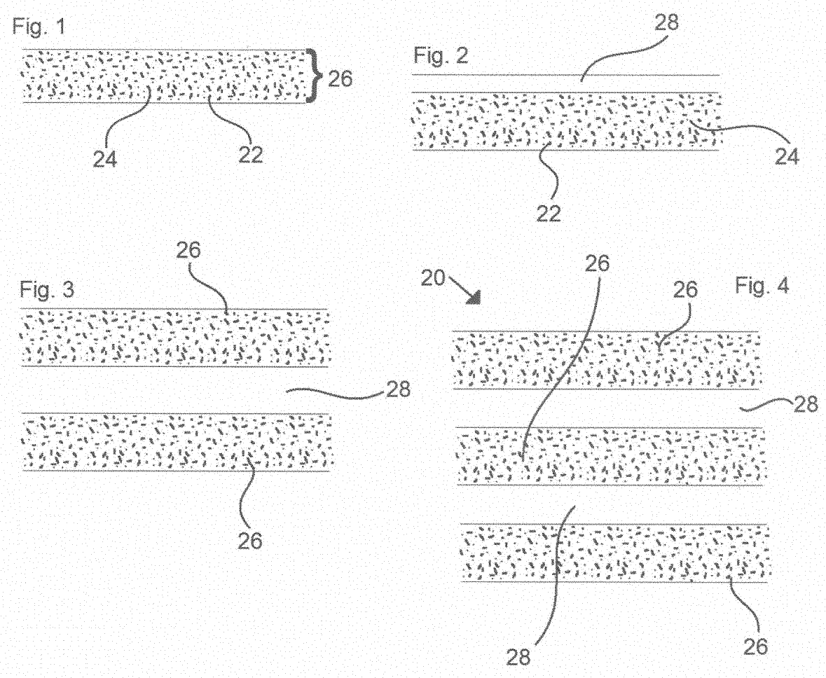

FIG. 1 shows a schematic representation of an inventive composite material element in the form of a cross section,

FIG. 2 shows a second variation of an inventive composite material element with a laminate layer arranged on the outside thereof,

FIG. 3 shows a third variation of an inventive composite material element in the form of a core layer with two mixed layers,

FIG. 4 shows a fourth variation of an inventive composite material element with three mixed layers,

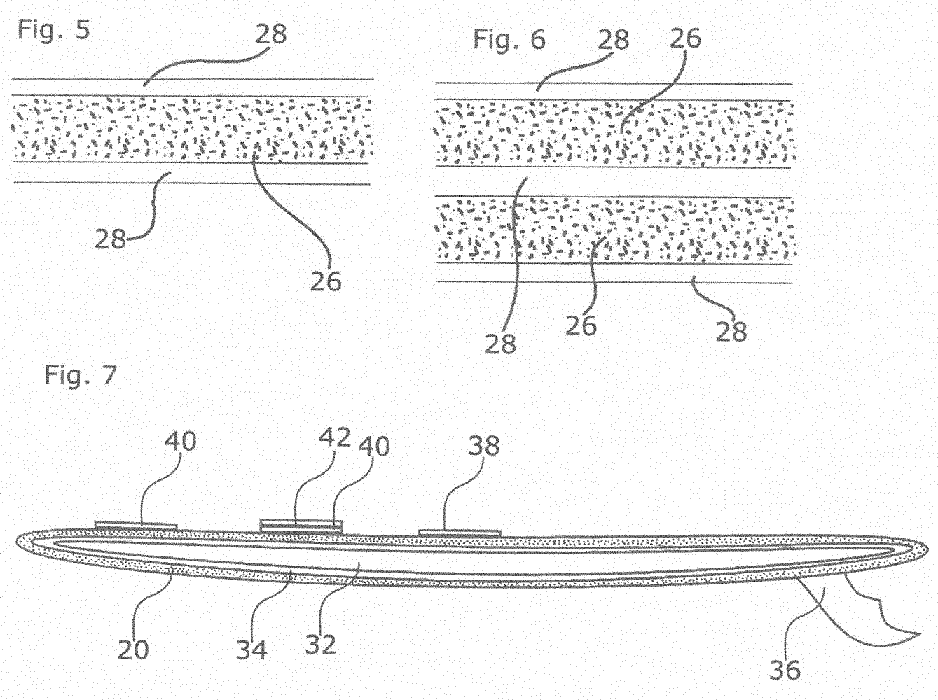

FIG. 5 shows another variation of an inventive composite material element with an additional top layer and an additional bottom layer,

FIG. 6 shows another variation of an inventive composite material element with two mixed layers and three additional layers, and

FIG. 7 shows a simplified schematic representation of a surfboard comprising an inventive composite material element in the form of a cross section.

FIG. 1 shows an inventive composite material element 20, which is composed of cork granules 22 and short fibers 24, in the form of a cross section. The cork granules 22 and the short fibers 24 jointly form a mixed layer 26.

In the exemplary embodiment illustrated in FIG. 2, a laminate layer 28 is arranged on the outside of the mixed layer 26.

FIG. 3 shows a variation, in which mixed layers 26 are located on the outer sides of a composite material element 20 such that they form a top layer and a bottom layer. The laminate layer 28, which consists of a different material with other physical properties, is arranged between the two mixed layers 26.

FIG. 4 shows a variation that comprises a total of five layers, wherein the mixed layers 26 are once again arranged on the outside and a laminate layer 28 respectively borders on said mixed layers in the direction of the interior of the composite material element 26. A third mixed layer 26 is located in the interior of the composite material element 20 shown.

FIGS. 5 and 6 show variations of the inventive composite material element 20, in which laminate layers 28 are respectively arranged on the outer sides. In the variation according to FIG. 5, only one mixed layer 26 is provided in the interior whereas two mixed layers 26 are provided in the variation according to FIG. 6. The composite material element 20 according to FIG. 6 comprises a third laminate layer 28 in its interior.

FIG. 7 shows a cross section through a surfboard 30 in the form of an exemplary schematic representation. This surfboard comprises a foam core 32 that is surrounded by a carbon layer 34. The outside of this carbon layer is surrounded by an inventive mixed layer 26. A fin 36, as well as a carbon element 38, a glass element 40 and a cork granule element 42, are furthermore visible on the outer side.

The exemplary embodiments according to FIGS. 2-6 are particularly suitable as a laminate encasement for a foam core, e.g. a surfboard 30.

The invention is not limited to the composite material elements shown, but rather also comprises other inventive variations. The layer structure may differ from the variations shown, for example, in dependence on the demands on the composite material element 20.

According to the invention, the inventive mixed layer 26 may basically also be used as a semi-finished product. It is particularly suitable, for example, for the manufacture of various composite components.

It was determined that the inventive mixed layer 26 is also suitable, for example, as a floor covering. This is advantageous because the mixed layer 26 provides an exceptionally high sound absorption, as well as thermal insulation.

The mixed layer 26 can be installed on the floor in the form of solid elements such as tiles, but the mixed layer 26 can in a particularly advantageous variation also be applied to the floor while it is still in its liquid state. It can be poured and subsequently cures. In this way, a seamless and exceptionally plane floor covering is achieved.

1. A composite material element (20), particularly for the manufacture of sports equipment, characterized in that it comprises at least one mixed layer (26) of cork granules (22) and short fibers (24).

2. The composite material element (20) according to claim 1, characterized in that the short fibers (24) consist of at least one material of the group comprising carbon, cotton, flax, basalt, glass, synthetic fibers (Vectran), aramide, coconut, hemp, silk, wool, bamboo, kozo, gampi, abaca, pine kraft and jute.

3. The composite material element (20) according to claim 1, characterized in that the short fibers (24) have a length between 0.05 mm and about 6 mm, preferably between 0.1 mm and 0.3 mm.

4. The composite material element (20) according to claim 1, characterized in that the cork granules have a density of about 50 kg/m³-300 kg/m³, particularly 90 kg/m³-250 kg/m³.

5. The composite material element (20) according to claim 1, characterized in that the mixed layer (26) furthermore comprises a synthetic resin and/or bioresin.

6. The composite material element (20) according to claim 5, characterized in that the synthetic resin is a synthetic resin of the group comprising epoxy resin, polyurethane, vinyl ester, acrylic resin, phenol resin, bioresin and polyester.

7. The composite material element (20) according to claim 1, characterized in that it comprises at least one additional laminate layer (28) of a different material.

8. The composite material element (20) according to claim 7, characterized in that the mixed layer (26) is arranged centrally in the form of a core layer referred to a cross section.

9. The composite material element (20) according to claim 7, characterized in that the mixed layer (26) is arranged on the outside.

10. The composite material element (20) according to claim 9, characterized in that two mixed layers (26) are provided and respectively arranged on the outside, and in that the laminate layer (28) is arranged in the interior between the two mixed layers (26).

11. The composite material element (20) according to claim 7, characterized in that the laminate layer (28) is made of at least one material of the group comprising glass, cotton, flax, basalt, glass, carbon, synthetic fibers (Vectran), hybrid fibers, aramide, coconut, hemp, silk, wool, bamboo, kozo, gampi, abaca, pine kraft and jute.

12. The composite material element (20) according to claim 1, characterized in that it predominantly comprises biodegradable materials.

13. The composite material element (20) according to claim 1, characterized in that a layer consisting of cork granules and synthetic resin is arranged on the outside.

14. The composite material element (20) according to claim 13, characterized in that the outer layer is colored black.

15. The use of a composite material element (20) according to claim 1 in water sports equipment, particularly a sailboard, surfboard, kiteboard, skateboard or hoverboard, in an aircraft, road vehicle, watercraft or building or in a wind power plant.

16. A method for manufacturing a composite material element (20), comprising the following steps:
grinding cork into cork granules (22),
producing short fibers (24) of a second material,
mixing and bonding the cork granules (22) with the short fibers (24),
curing the mixture of cork granules (22) and short fibers (24).

17. The method according to claim 16, characterized by the addition of a synthetic resin.

18. The method according to claim 16, characterized in that the mixture is compressed under pressure.

19. The method according to claim 18, characterized by a compression under vacuum.
